(19) United States
(12) Patent Application Publication
(10) Pub. No.: US 2008/0290535 A1
(43) Pub. Date: Nov. 27, 2008

(54) REDUCTION OF EXCESS POLYMERIC FLASH RING

(76) Inventors: Frank F. Molock, JR., Orange Park, FL (US); Changhong Yin, St. Augustine, FL (US); Scott F. Ansell, Jacksonville, FL (US); Michael J. Strong, Jacksonville, FL (US); John C. Heaton, Atlantic Beach, FL (US); Eric Hammitt, Grandin, FL (US); William McKee, Claney Strand Limerick (IE); Jason Tokarski, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/753,076

(22) Filed: May 24, 2007

(51) Int. Cl. B29D 11/00

(52) U.S. Cl. 264/2.6; 264/1.1

(57) ABSTRACT

The present invention includes methods and apparatus for forming a biomedical device, such as an ophthalmic lens, in a area defined by a first mold part and a second mold part wherein during the formation of the biomedical device a HEMA is formed and the HEMA ring and a greater adhesive force is generated on the HEMA ring by the second mold part than the first mold part.

### FIELD OF THE INVENTION

This invention relates to methods and apparatus for employing a surfactant to assist in the release of mold components from each other during molding of polymeric articles; such as, ophthalmic lenses. The surfactant is applied in the form of a film or coating on surface portions of one of the mold components in order to facilitate the disengagement between the mold components during demolding, and the removal of excess polymeric molding material adhesively deposited on surfaces thereon.

### BACKGROUND OF THE INVENTION

It is well known that contact lenses can be used to improve vision. Various contact lenses have been commercially produced for many years. Early designs of contact lenses were fashioned from hard materials. Although these lenses are still currently used in some applications, they are not suitable for all patients due to their poor comfort and relatively low permeability to oxygen. Later developments in the field gave rise to soft contact lenses, based upon hydrogels.

Hydrogel contact lenses are very popular today. These lenses are often more comfortable to wear than contact lenses made of hard materials. Malleable soft contact lenses can be manufactured by forming a lens in a multi-part mold where the combined parts form a topography consistent with the desired final lens.

During typical ophthalmic lens manufacturing processes, Front Curve (FC) and Back Curve (BC) molds are injection molded. A reaction mixture comprising a monomer or prepolymer is dosed into the FC mold. The BC mold is deposited on top of the FC to enclose the reaction mixture into a cavity with the appropriate lens geometry. This assembly is exposed to light, which allows the monomer to polymerize or cure, to create the ophthalmic lens. After the lens is cured, a demold process is used to mechanically pry the BC mold away from the lens and FC mold. Finally, the lens and FC are submersed in fluid and the lens releases from the FC mold.

Following cure, traditional practice dictates that the mold portions are separated and the ophthalmic lens remains adhered to one of the mold portions, typically, a FC mold part. Excess molding material encountered during the molding of the contact lenses is expelled from the mold cavities and thereby adhesively deposited in the shape of rings on surface portions between the mold components located externally about the mold cavities. Hydrophilic contact lenses of the type considered herein are usually constituted from a hydrophilic polymer, preferably a HEMA-based polymer (hydroxyethylmethacrylate), although other suitable monomers may comprise hydroxy ethyl acrylate (HEA), hydroxypropyl methacrylate, hydroxy propyl acrylate and hydroxy trimethyl ethylene acrylate, among numerous other applicable materials.

In order to remove the molded hydrophilic contact lenses from the respective mold cavities, separation of the mold halves or portions is implemented, and the formed contact lenses may then be removed from the mold cavities. Due to excess portions of the polymeric material of the hydrophilic contact lenses which are expelled from the mold cavities of the cooperating mold components, and which form ring-shaped elements of the HEMA-based polymer from which the contact lenses are made surrounding the exteriors of the mold cavities, and exhibit tendencies to strongly adhere to the mold surfaces on which the rings are deposited. Such rings make separating of the mold cavities difficult, resulting in mold breakage and damage to the lenses. Further, the rings, or fragments thereof, become uncontrollable debris in automated production lines, contaminating both the production line and the final lens package. Moreover, the foregoing can also conceivably cause a perfectly “good” contact lens to be rejected after demolding due to the formed HEMA-ring or a portion thereof remaining on the front curve of the mold. This results in uneconomical production conditions being encountered during the manufacture of such contact lenses.

Increasing BC mold surface energy through mechanical roughing BC mold or use of HEMA ring puller insert may reduce but has been shown to not be sufficient to eliminate HEMA ring attaching to the FC mold.

Therefore, it would be advantageous to provide apparatus and methods, which facilitate separation of mold parts with any HEMA ring formed being consistently adhered to a designated mold part, such as a base curve for easy disposal.

### SUMMARY OF THE INVENTION

Accordingly, the present invention provides a solution to HEMA ring adherence to a front curve mold part by using a surfactant stamp of particular mixtures of surfactants. The surfactant is applied in the form of a film or coating on the FC flange in order to facilitate the disengagement between the mold components ( BC and FC) during demolding, and the removal of excess polymeric flash ring adhesively deposited on the FC flange. Application can be accomplished, for example with a stamping mechanism.

According to the present invention, Tween 80, which is a water-soluble based surfactant and HEMA ring (the excess of Etafilcon A monomer) both contain water. HEMA ring material therefore has a tendency to mix or “leak” to the flange of FC mold causing HEMA ring close to the front curve plastic. Additionally, Tween 80 has low viscosity and low surfactant volume on the FC flange. It requires perfect alignment between the stamp pad and FC flange. Otherwise, low viscosity Tween 80 may “flow” from the high side to low side and create undesired dry spots or dry areas on the FC flange. The dry spot or dry areas on the FC flange are one of the major root causes for HEMA ring attaching to the FC flange instead of the BC mold. The combination of Tween 80 with Span 80 overcomes these difficulties and provides an improved method of HEMA ring removal from a desired mold part, such as a FC mold part.

According to the present invention, a mixture of Span 80 and Tween 80 provide improved HEMA ring control and combine the relatively high viscosity of Span 80 to allow surfactant printed in volume evenly on the FC flange and the wettability and flowability of Tween 80 thereby providing for even distribution.

### DESCRIPTION OF THE DRAWINGS

FIG. 1 illustrates a diagram of an ophthalmic lens mold assembly.

FIG. 1A illustrates a diagram of an ophthalmic lens mold assembly with a formed lens and HEMA ring.

FIG. 2 illustrates a flow diagram of method steps that may be implemented according to some embodiments of the present invention.

FIG. 3 illustrates a block diagram of apparatus that may be used to implement some embodiments of the present invention.

FIG. 4 illustrates a top down view of an ophthalmic lens mold part.

### DETAILED DESCRIPTION OF THE INVENTION

Generally, the present invention is directed to methods and apparatus for application of a surfactant, such as a mixture of Tween 80 and Span 80 to a flange area of a front curve mold part used to form an ophthalmic lens. The surfactant can be applied, for example, via a stamp.

Mold parts used to form ophthalmic lenses can be injection molded from materials such as polypropylene (PP) and polystyrene (PS). PP typically has lower surface energy than PS. Therefore, using the combination of PP as base curve mold (BC) and PS as front curve mold (FC) provides easy demolding of BC while maintaining lens inside the FC and improved lens edge quality. However, lower surface energy PP as BC mold often yields undesired HEMA rings attaching to the flange of FC mold resulting in reduced lens yield and possible lens edge defects.

Tween 80 (Polyoxyethylene sorbate monooleate), can be used as a processing aid for contact lens demolding. Tween 80 is a hydrophilic surfactant and some lens forming monomers, such as, etafilcona-A monomer are also largely hydrophilic. Therefore, Tween 80 and HEMA ring (cured excess monomer) intend to mix well each other and thereby become difficult to separate. This results in a HEMA ring attaching to the flange of FC mold. According to the present invention, application of a layer of a mixture of Span 80 (Sorbitan monooleate) and Tween 80 significantly reduce and/or eliminate the HEMA rings attaching on the PS FC flange.

Methods and apparatus for applying a surfactant to a mold surface are well known and described, for example in U.S. Pat. No. 5,639,510 and U.S. Pat. No. 5,837,314.

As used here, the term “mold” refers to a rigid or semi-rigid object that may be used to form lenses from uncured formulations. The preferred molds are two part molds including a front curve mold and a back curve mold, as described above.

As used herein, “released from a mold,” means that a lens is either completely separated from the mold, or is only loosely attached so that it can be removed with mild agitation or pushed off with a swab.

### Lenses

As used herein “lens” refers to any ophthalmic device that resides in or on the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision. In some embodiments, the preferred lenses of the invention are soft contact lenses are made from silicone elastomers or hydrogels, which include but are not limited to silicone hydrogels, and fluorohydrogels.

As used herein, the term “lens forming mixture” or “Reaction Mixture” refers to a monomer or prepolymer material which can be cured, to form an ophthalmic lens. Various embodiments can include lens forming mixtures with one or more additives such as: UV blockers, tints, photoinitiators or catalysts, and other additives one might desire in an ophthalmic lenses such as, contact or intraocular lenses. Lens forming mixtures are more fully described below.

### Molds

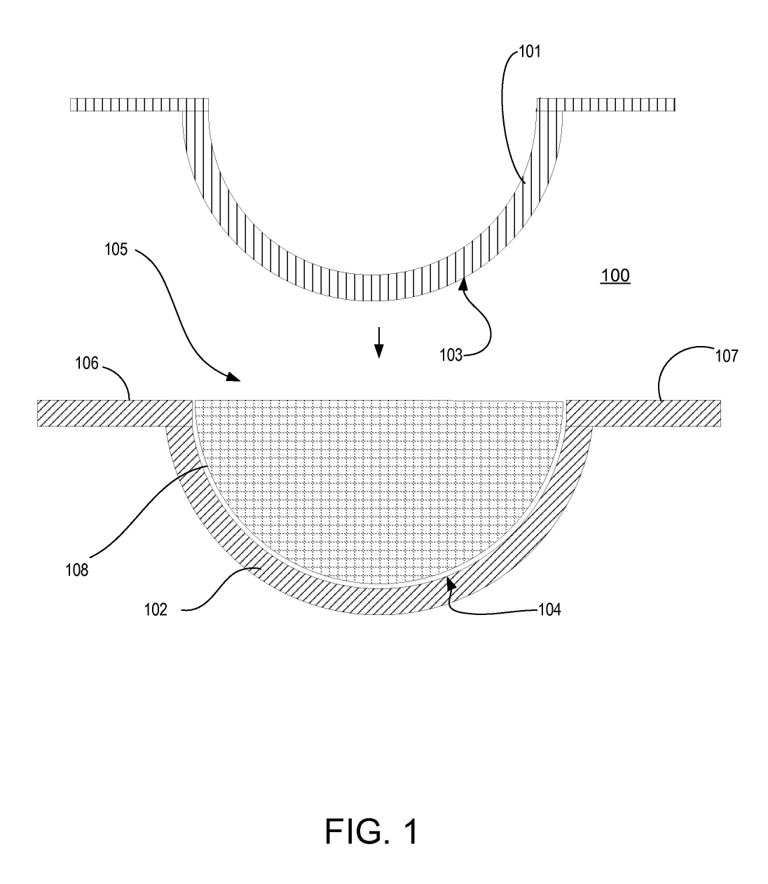

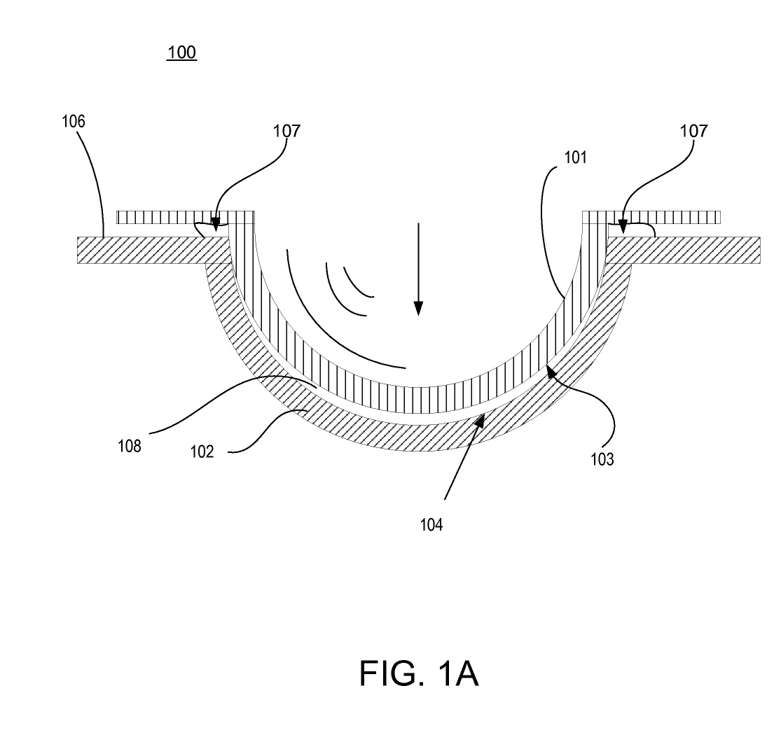

Referring now to FIG. 1, a diagram of an exemplary mold for an ophthalmic lens is illustrated. As used herein, the terms “mold” and “mold assembly” refer to a form 100 having a cavity 105 into which a lens forming mixture can be dispensed such that upon reaction or cure of the lens forming mixture, an ophthalmic lens 108 of a desired shape is produced. The molds and mold assemblies 100 of this invention are made up of more than one “mold parts” or “mold pieces” 101-102. The mold parts 101-102 can be brought together such that a cavity 105 is formed by combination of the mold parts 101-102 and a lens 108 can be fashioned in the cavity 105. This combination of mold parts 101-102 is preferably temporary. Upon formation of the lens, the mold parts 101-102 can again be separated for removal of a fashioned lens (not shown.

A “mold part” as the term is used in this specification therefore refers to a portion of mold 101-102, which when combined with another portion of a mold 101-102 forms a mold 100 (also referred to as a mold assembly 100). At least one mold part 101-102 is designed to have at least a portion of its surface 103-104 in contact with the lens forming mixture such that upon reaction or cure of the lens forming mixture that surface 103-104 provides a desired shape and form to the portion of the lens with which it is in contact. The same is true of at least one other mold part 101-102.

Thus, for example, in a preferred embodiment a mold assembly 100 is formed from two parts 101-102, a female concave piece (front curve mold part) 102 and a male convex piece (back curve mold part) 101 with a cavity 105 formed therebetween. The portion of the concave surface 104 which makes contact with Reaction Mixture has the curvature of the front curve of an ophthalmic lens 108 to be produced in the mold assembly 100 and is sufficiently smooth and formed such that the surface of a ophthalmic lens 108 formed by polymerization of the reaction mixture which is in contact with the concave surface 104 is optically acceptable.

The back curve mold part 101 has a convex surface 103 in contact which contacts the lens forming mixture and has the curvature of the back curve of a ophthalmic lens to be produced in the mold assembly 100. The convex surface 103 is sufficiently smooth and formed such that the surface of a ophthalmic lens formed by reaction or cure of the lens forming mixture in contact with the back surface 103 is optically acceptable. Accordingly, any such surface 103-104 can have an optical quality surface finish, which indicates that it is sufficiently smooth and formed so that a lens surface fashioned by the polymerization of a lens forming material in contact with the molding surface is optically acceptable. Further, in some embodiments, the lens forming surface 103-104 can have a geometry that is necessary to impart to the lens surface the desired optical characteristics, including without limitation, spherical, aspherical and cylinder power, wave front aberration correction, corneal topography correction and the like as well as any combinations thereof. Generally, the inner concave surface 104 of the front curve mold part 102 defines the outer surface of the ophthalmic lens 108, while the outer convex surface 103 of the back mold piece 101 defines the inner surface of the ophthalmic lens 108. A flange area 106 can be used to support the lens forming areas 103-104 and also to facilitate handling of the mold parts 101-102.

According to various embodiments, the molds of the invention may contain polymers such as polypropylene, polyethylene, polystyrene, polymethyl methacrylate, and modified polyolefins. In addition, some embodiments can contain blends of polymers, such as, for example, a blend of the water soluble polymer and polypropylene (Zieglar Natta or metallocene catalyst process with nucleation) may be used, where the ratio by weight percentage of water soluble polymer to polypropylene ranges from about 99:1, to about 10:90 respectively. Such blends can be used on either or both mold parts 101-102. In some embodiments, it is preferred that such blend is used on the back curve and the front curve consists of a cyclic olefin.

In some embodiments, the molds of the invention may contain additives that facilitate the separation of the lens forming surfaces, reduce the adhesion of the cured lens to the molding surface, or both. For example, additives such as metal or ammonium salts of stearic acid, amide waxes, polyethylene or polypropylene waxes, organic phosphate esters, glycerol esters or alcohol esters may be added to the material used to form the mold parts 101-102 prior to forming the mold.

Examples of additives which may be added to the mold part material may include, but are not limited to: Dow Siloxane MB50-321 and Dow Siloxane MB50-321 (a silicone dispersion), Nurcrel 535 & 932 (ethylene-methacrylic acid co-polymer resin Registry No. 25053-53-6), Erucamide (fatty acid amide Registry No. 112-84-5), Oleamide (fatty acid amide Registry No. 301-02-0), Mica (Registry No. 12001-26-2), Atmer 163 (fatty alkyl diethanolamine Registry No. 107043-84-5), Pluronic (polyoxypropylene-polyoxyethylene block co-polymer Registry No.106392-12-5), Tetronic (alkyoxylated amine 110617-70-4), Flura (Registry No.7681-49-4), calcium stearate, zinc stearate, Super-Floss anti block (slip/anti blocking agent, Registry No. 61790-53-2), Zeospheres anti-block (slip/anti blocking agent); Ampacet 40604 (fatty acid amide), Kemamide (fatty acid amide), Licowax fatty acid amide, Hypermer B246SF, XNAP, polyethylene glycol monolaurate (anti-stat) epoxidized soy bean oil, talc (hydrated Magnesium silicate), calcium carbonate, behenic acid, pentaerythritol tetrastearate, succinic acid, epolene E43-Wax, methyl cellulose, cocamide (anti-blocking agent Registry No. 61789-19-3), poly vinyl pyrrolidinone (360,000 MW).

As used herein, the term “uncured” refers to the physical state of a reaction mixture (sometimes referred to as “lens formulation”) prior to final curing to form a lens 108. Some lens formulations contain mixtures of monomers which are cured only once. Other lens formulations contain monomers, partially cured monomers, macromers, prepolymers and other components.

Referring now to FIG. 1A, a cross section of mold parts 101-102 as they are engaged with each other to form an ophthalmic lens 108. In addition, excess Reaction Mixture can be forced around the flange area 106 to create a HEMA ring 107.

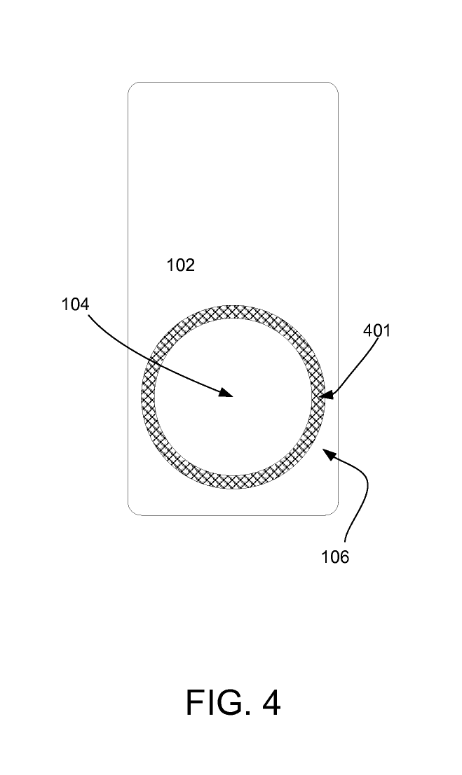

Referring now to FIG. 4, a top down view of a mold part according to the present invention is illustrated and additionally shows an area 401 that can receive a layer of surfactant, such as through a stamping process. According to the present invention, the layer of surfactant can include, for example, a mixture of Span 80 and Tween 80.

### Method Steps

Further this invention includes a method of making an ophthalmic lens with steps that include dispensing an uncured lens reaction mixture into a mold comprising, consisting essentially of, or consisting of, a water soluble polymer. In some embodiments, the water soluble polymer can include modified PVOH, such as, for example, Aqua-Sol 1220.

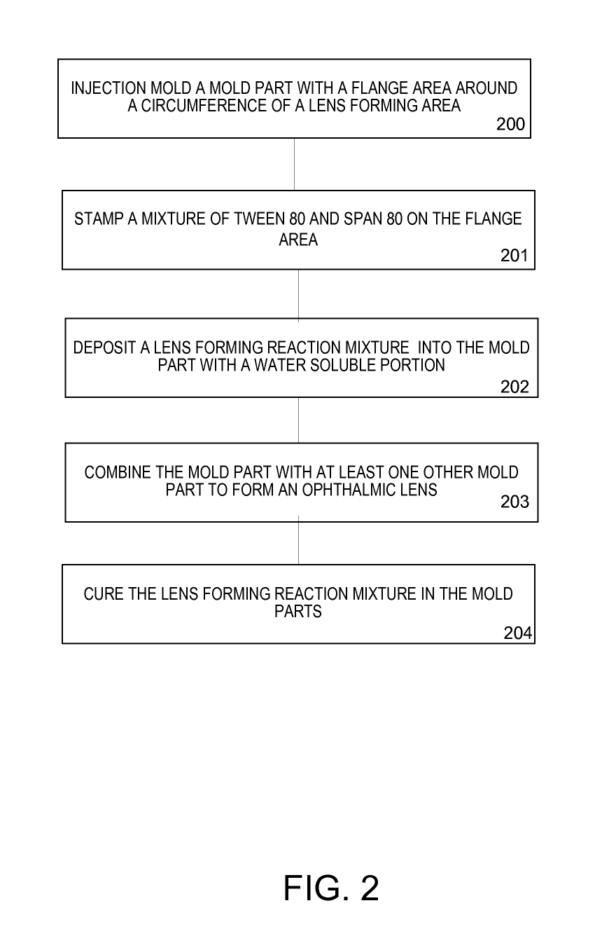

Referring now to FIG. 2, a flow diagram illustrates exemplary steps that may be implemented in some embodiments of the present invention. It is to be understood that some or all of the following steps may be implemented in various embodiments of the present invention.

At 200, injection molding processes are used to form one or more mold parts 101-102 which in turn may be used to manufacture a biomedical device.

At 201, a surfactant, such as for example, a mixture of Span 80 and Tween 80 is applied to a portion of the mold part to which it is desirable reduce any adhesive force that may develop between the mold part and a Reaction Mixture subsequently deposited onto the mold part 101-102.

At 202, the Reaction Mixture is deposited into a first mold part 102, which is utilized to shape the ophthalmic lens 108.

At 203, the first mold part 102 can be combined with at least one other mold part 101-102 to shape the deposited Reaction Mixture into the desired shape of a biomedical device, such as an ophthalmic lens 108.

At 204, the Reaction Mixture is cured and formed into a lens 108. Curing can be accomplished, for example, by various means known in the art, such as, for example, exposure of the reaction mixture to actinic radiation, exposure of the reaction mixture to elevated heat (i.e. 40° C. to 75° C.), or exposure to both actinic radiation and elevated heat.

### Apparatus

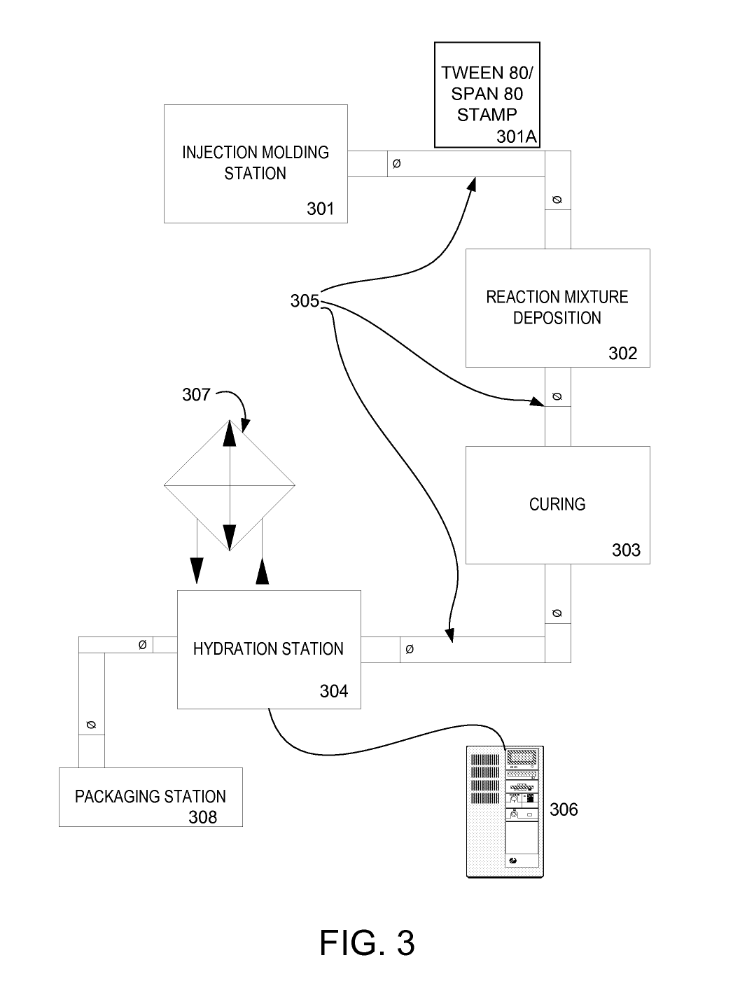

Referring now to FIG. 3, a block diagram is illustrated of apparatus contained in processing stations 301-304 that can be utilized in implementations of the present invention. In some preferred embodiments, processing stations 301-304 can be accessible to ophthalmic lenses 100 via a transport mechanism 305. The transport mechanism 305 can include for example one or more of: a robot, a conveyor and a rail system in conjunction with a locomotion means that may include, a conveyor belt, chain, cable or hydraulic mechanism powered by a variable speed motor or other known drive mechanism (not shown).

Some embodiments can include back surface mold parts 101 placed in pallets (not shown). The pallets can be moved by the transport mechanism 305 between two or more processing stations 301-304. A computer or other controller 306 can be operatively connected to the processing stations 301-304 to monitor and control processes at each station 301-304 and also monitor and control the transport mechanism 305 to coordinate the movement of lenses between the process stations 301-304.

Processing stations 301-304 can include, for example, an injection molding station 301. At the injection molding station 301, injection molding apparatus forms mold parts 101-102 suitable for manufacturing a desired biomedical device, such as the ophthalmic lens 108. At station 301A, stamping apparatus, such as the apparatus described in U.S. Pat. Nos. 5,837,314 and 5,639,510 can be used to apply a mixture of Span 80 and Tween 80, or other surfactant or other adhesion diminishing material, onto an area of at least one mold part. In some preferred embodiments, the area to which the adhesion diminishing material is applied includes a circumference area surrounding a lens forming surface, such as a flange area.

Processing station 302 can include a deposition station, which deposits a quantity of a Reaction Mixture into the front curve mold portion 102, and preferably completely cover the lens forming mold surface 104 with the Reaction Mixture. The Reaction Mixture should comprise any material or mixture of materials, which upon polymerization yields an optically clear, integral shape-sustaining contact lens or contact lens precursor, such as, for example, a silicone hydrogel monomer or prepolymer.

A curing station 303 can include apparatus for polymerizing the Reaction Mixture. Polymerization is preferably carried out by exposing the Reaction Mixture to a source of initiation which can include for example, one or more of: actinic radiation and heat. Curing station 302 therefore includes apparatus that provide a source of initiation of the Reaction Mixture deposited into the front curve mold 102. In some embodiments, actinic radiation can be sourced from bulbs under which the mold assemblies travel. The bulbs can provide an intensity of actinic radiation in a given plane parallel to the axis of the bulb that is sufficient to initiate polymerization.

In some embodiments, a curing station 303 heat source can be effective to raise the temperature of the Reactive Mixture to a temperature sufficient to assist the propagation of the polymerization and to counteract the tendency of the Reaction Mixture to shrink during the period that it is exposed to the actinic radiation and thereby promote improved polymerization. Some embodiments can therefore include a heat source that can maintain the temperature of the Reaction Mixture (by which is meant that resin before it begins to polymerize, and as it is polymerizing) above the glass transition temperature of the polymerized product or above its softening temperature as it is polymerizing. Such temperature can vary with the identity and amount of the components in the Reaction Mixture. In general, some embodiments include apparatus capable of establishing and maintaining temperatures on the order of 40° C. degree to 75° C.

In some embodiments, a source of heat can include a duct, which blows warm gas, such as, for example, N₂ or air, across and around the mold assembly as it passes under the actinic radiation bulbs. The end of the duct can be fitted with a plurality of holes through which warm gas passes. Distributing the gas in this way helps achieve uniformity of temperature throughout the area under the housing. Uniform temperatures throughout the regions around the mold assemblies can facilitate more uniform polymerization.

In some embodiments, polymerization of Reaction Mixture can be carried out in an atmosphere with controlled exposure to oxygen, including, in some embodiments, an oxygen-free environment, because oxygen can enter into side reactions which may affect a desired optical quality, as well as the clarity of the polymerized lens. In some embodiments, the lens mold halves are also prepared in an atmosphere that has limited oxygen or is oxygen-free. Methods and apparatus for controlling exposure to oxygen are well known in the art.

The hydration station 304 can be used to expose the mold parts and newly formed lens to an aqueous solution. Some alternate embodiments can also include a demold station (not shown) to demold the mold parts 101-102 of those embodiments with a mold part with only some material which is water soluble.

In some embodiments, a cured lens which includes a polymer/diluent mixture can also be treated by exposure to a hydration solution at a hydration station 304 to remove diluent from the lens 108 and ultimately replace the diluent with water, such as a silicone hydrogel ophthalmic lens formed having a final size and shape which are quite similar to the size and shape of the original molded polymer/diluent article.

In some embodiments, a heat exchanger 307 is used to maintain the temperature of the hydration solution at a temperature greater than typical ambient room temperature. For example, and without limitation, a heat exchanger can be used to raise the temperature of the hydration solution to about 60° C. to about 95° C.

### Lens Materials

As used herein “lens” refers to any ophthalmic device that resides in or on the eye. These devices can provide optical correction or may be cosmetic. The term lens includes but is not limited to soft contact lenses, intraocular lenses, overlay lenses, ocular inserts, and optical inserts. In some embodiments, preferred lenses of the invention are soft contact lenses are made from silicone elastomers or hydrogels, which include but are not limited to silicone hydrogels, and fluorohydrogels. Soft contact lens formulations are well known and disclosed in numerous U.S. patents.

Other preferred embodiments of the resent invention can include lenses of etafilcon A, genfilcon A, lenefilcon A, polymacon, acquafilcon A, balafilcon A, lotrafilcon A, galyfilcon A, senofilcon A, silicone hydrogels. Other embodiments can include ophthalmic lenses made from prepolymers. These patents as well as all other patent disclosed in this application are hereby incorporated by reference in their entirety.

### Adhesion Diminishing Material

Adhesive diminishing materials, such as surfactants, can be characterized according to a balance between hydrophilic (water-loving) and hydrophobic (oil-loving) portions of their molecules. The hydrophilic and hydrophobic balance number (HLB) indicates the polarity of the molecules in an arbitrary range of 1 to 40, with the most commonly used emulsifiers having a value between 1 and 20. The lower the HLB value, the more hydrophobic the emulsifier is. The HLB number increases with increasing hydrophilicity. According to the HLB number surfactants may be utilized for different purposes.

Oils can also have HLB values assigned. However, this “HLB” is relative as to whether an oil-in-water emulsion is to be stabilized. Emulsifiers typically have similar HLB values to those of respective oils in order to achieve maximum stabilization. Mineral oil was an assigned HLB number of 4 when a water-in-oil emulsion is to be prepared. Accordingly, the HLB number of the emulsifier should be around 4 and 10.5, respectively. The desired HLB numbers can also be achieved by mixing hydrophobic and hydrophilic surfactants. The overall HLB value of the mixture is calculated as the sum of the weight fraction * individual HLB, such as:

Xa*A+(1−Xa)*B=HLB (mixture), where Xa is the weight fraction of emulsifier A.

In some preferred embodiments, a surfactant can have preferable characteristics, such as: a melt temperature that is no greater than 30° C.; low solubility of the surfactant in a HEMA ring; and a viscosity which is between 80 to 1000 cps.

In some embodiments, the diluent can be particularly polar wherein it becomes more important that surfactants present a impregnable layer towards the HEMA ring in order to prevent any curable components to get close to, or contact, the FC plastic. In some preferred embodiments therefore, the following characteristics can be present:

Summary of Surfactant HLB

| | |
|---|---|
| Antiforming agent | 1 to 3 |
| Emulsifier, water-in-oil | 3 to 6 |
| Wetting agent | 7 to 9 |
| Emulsifier, oil-in-water | 8 to 18 |
| Detergent | 13 to 15 |
| Solubilizer | 15 to 20 |

and

Appearance of Surfactants/Size

| | | |
|---|---|---|
| >1 | μm | Milky |
| >0.1 to 1 | μm | Blue White |
| >0.05 to 0.1 | μm | Gray semi-transparent |
| <0.05 | μm | Transparent |

According to the present invention the use of mixture of Span 80 (Sorbitan monooleate) and Tween 80 (Polyoxyethylene sorbate monooleate) significantly reduce and sometimes eliminate the HEMA rings attaching on a designated mold part flange, such as a polystyrene FC flange. Tween 80 is a hydrophilic surfactant and etafilcon-A monomer is also largely hydrophilic. Therefore, a stamp of Tween 80 and HEMA ring of cured excess monomer have a tendency to mix well each other and become hard to separate. This can result in a HEMA ring attaching to the flange of FC mold which is typically not the result desired. However, it has been discovered that application of a mixture of Tween 80 and Span 80 to the FC mold part flange unexpectedly diminishes the likelihood of the HEMA ring adhering to the FC flange.

### EXAMPLE 1

| | | | Monomer Dose | HEMA Ring |
|---|---|---|---|---|
| | FC | BC | Volume | Defect Rate |
| Surfactant | Mold | Mold | (mg/cavity) | (%) |
| Tween 80 | PS | PP | 56 | 37.8% |
| Tween 80 | PS | PP | 73 | 12.3% |
| Tween 80 | PS | PP | 86 | 3.3% |
| 25% Tween 80 + | PS | PP | 79 | 0.02%* |
| 75% Span 80 | | | | |

*Only 5 HEMA rings attaching to the FC flange based on demold audit on 27,896 lenses during the sample runs.

### EXAMPLE 2

| | | | HEMA Ring |
|---|---|---|---|
| BC | | Dose Volume | Defect Rate |
| Mold | Surfactant | (mg/cavity) | (%) |
| PP | 100% w.t. Tween 80 | 79-86 | 1.1-6.7% |
| PP | 50% w.t. Tween 80 + 50% | 79 | 0.4% |
| | w.t. Span 80 | | |
| PP | 25% Tween w.t. + 75% | 79 | 0.0% |
| | w.t. Span 80 | | |
| PS | 100% w.t. Tween 80 | 79 | 1.8%-2.8% |
| PS | 25% Tween w.t. + 75% | 79 | 0.3 |
| | w.t. Span 80 | | |

In various embodiments of the present invention, the surfactant mixtures can be from 1% w.t. Span 80 (99% w.t. Tween 80) to 100% w.t. pure Span 80. In some embodiments, mixtures of Span 80 and Tween 80 can be from 25% w.t. Span 80 (75% w.t. Tween 80) to 95% w.t. Span 80 (5% w.t. Tween 80). In some embodiments, preferred mixtures of Span 80 and Tween 80 can be from 50% w.t. Span 80 (50% w.t. Tween 80) to 88% w.t. Span 80 (12% w.t. Tween 80), while the most preferred mixture includes 75% w.t. Span 80+25% w.t. Span 80.

Accordingly, the present invention provides mold parts, as well as methods and apparatus for forming the mold parts. According to the present invention, at least a portion of the mold part is formed from a water soluble material and a second material. While the present invention has been particularly described above and drawings, it will be understood by those skilled in the art that the foregoing ad other changes in form and details may be made therein without departing from the spirit and scope of the invention, which should be limited only by the scope of the appended claims.

What is claimed is:

1. A method of reducing the adherence of a reaction mixture to a portion of a mold part used to fashion an ophthalmic lens, the method comprising:
applying a mixture of Span 80 and Tween 80 to a portion of a surface area of the first mold part for which adherence of the reaction mixture will be reduced;
engaging the first mold part with a second mold part with the reaction mixture therebetween and a least a portion of the reaction mixture in contact with the portion of the surface area of the first mold part to which the mixture of Span 80 and Tween 80 has been applied; and
curing the reaction mixture thereby causing an adhesive force between the cured reaction mixture and each of the mold parts, wherein the adhesive force between the cured reaction mixture and the first mold part is reduced in the portion of the surface area to which the mixture of Span 80 and Tween 80 has been applied as compared to a surface area of the first mold part which did not have the mixture of Span 80 and Tween 80 applied.

2. The method of claim 1 additionally comprising the step of depositing reaction mixture into a portion of the first mold part.

3. The method of claim 1 wherein the mixture of Span 80 and Tween 80 comprises between about 1 % w.t. Span 80 to about 99% w.t. Span 80.

4. The method of claim 1 wherein the mixture of Span 80 and Tween 80 comprises about 50% w.t. Tween 80 and 50% w.t. Span 80.

5. The method of claim 1 wherein the mixture of Span 80 and Tween 80 comprises about 25% w.t. Tween 80 and 75% w.t. Span 80.

6. The method of claim 1 wherein the first mold part comprises polystyrene.

7. The method of claim 1 wherein the first mold part comprises polypropylene.

8. The method of claim 1 wherein the second mold part comprises a modified polyvinyl alcohol.

9. The method of claim 1 wherein the melt temperature of the mixture of Span 80 and Tween 80 is less than about 30° C.

10. The method of claim 1 wherein the hydrophobic balance number of the mixture of Span 80 and Tween 80 is between 4 and 15.

11. The method of claim 1 wherein the hydrophobic balance number of the mixture of Span 80 and Tween 80 is between 5 and 10.

12. The method of claim 1 wherein the first mold part comprises a lens forming surface area which is generally circular in shape and the portion of a surface area of the first mold part for which adherence of the reaction mixture will be reduced borders the circumference of the lens forming area.

13. The method of claim 12 additionally comprising the steps of:
forming a HEMA ring around the circumference of the lens forming area and between the first mold part and the second mold part;
separating the first mold part and the second mold part; and
removing the HEMA ring from the first mold part.

14. The method of claim 13 wherein the lens and the HEMA ring comprise etafilcon A.

15. A mold part assembly for forming an ophthalmic lens, the mold part assembly comprising:
a first mold part comprising a concave lens forming area and a first flange area surrounding the first lens forming area, wherein the first flange area is essentially flat;
a second mold part comprising a convex lens forming area; and
a layer of a surfactant comprising Span 80 and Tween 80 applied to the first flange area;
wherein the concave lens forming area can be engaged proximate to the convex lens forming area to create a cavity therebetween in the shape of an ophthalmic lens.

16. The mold part of assembly claim 15 wherein the second mold part additionally comprises a second flange area which is essentially flat and surrounds the convex lens forming area and which demonstrates a greater adhesive force on a HEMA ring formed between the first flange area and the second flange area.

17. The mold part of assembly claim 15 wherein the first mold part comprises polystyrene.

18. The mold part of assembly claim 15 wherein the first mold part comprises a cyclic polyolefin.

19. The mold part of assembly claim 15 wherein the second mold part comprises polystyrene

20. The mold part of assembly claim 15 wherein the second mold part comprises a cyclic polyolefin.

21. A method of forming a mold part for forming an ophthalmic lens, the method comprising the steps of:
injection molding a first mold part comprising a first material comprising polystyrene;
injection molding a second mold part comprising a second material comprising a cyclic polyolefin;
applying a layer of a mixture of Tween 80 and Span 80 around a circumference of a lens forming area on the first mold part;
combining the first mold part with a second mold part with a lens forming reaction mixture in between the first mold part and the second mold part, wherein the reaction mixture is formed by the first mold part and the second mold part into the shape of the ophthalmic lens and a HEMA ring;
curing the reaction mixture;
separating the first mold part and the second mold part such that the ophthalmic lens remains adhered to the first mold part and the HEMA ring remains adhered to the second mold part;
exposing the ophthalmic lens to an aqueous solution to release the lens from the first mold part.

22. The method of claim 21 wherein the second material comprises polypropylene.

23. The method of claim 21 wherein the mixture of Span 80 and Tween 80 comprises about 25% w.t. Tween 80 and 75% w.t. Span 80.
